(19) United States
(12) Patent Application Publication
(10) Pub. No.: US 2017/0248474 A1
(43) Pub. Date: Aug. 31, 2017

(54) WIRELESS COOKING THERMOMETER

(71) Applicants: Nels NIELSEN, Copenhagen (DK); Sune HØJFELDT, Copenhagen (DK)

(72) Inventors: Nels NIELSEN, Copenhagen (DK); Sune HØJFELDT, Copenhagen (DK)

(21) Appl. No.: 15/518,802

(22) PCT Filed: Oct. 14, 2015
(86) PCT No.: PCT/DK2015/050319

§ 371 Date: Apr. 13, 2017

(30) Foreign Application Priority Data
Oct. 14, 2014 (DK) PA 2014 00588
Jun. 16, 2015 (DK) PA 2015 00343

(51) Int. Cl. G01K 1/02

(52) U.S. Cl. CPC G01K 1/024; G01K 1/026; G01K 2207/06

(57) ABSTRACT

The present invention provides a wireless cooking thermometer system, comprising: a food temperature indicator configured to provide a temperature reading, and a wireless transmitter unit operably connected to the food temperature indicator to receive a temperature reading therefrom and to wirelessly transmit an information representing the temperature reading.

### FIELD AND BACKGROUND OF THE INVENTION

The present invention relates to a wireless cooking thermometer.

Cooking thermometers are popular accessories for cooks, especially grill enthusiasts. Cooking thermometers vary in measured-temperature indication as well as desired-temperature indication. Some cooking thermometers use a bimetallic strip that changes shape with changing temperature to move a pointer on a dial and thereby indicate a temperature. Other thermometers report temperatures on display screen such as a liquid crystal display (LCD) which is directly attached to the measuring unit. Yet, other thermometers report temperatures which are then transmitted to a detached display screen. For example, U.S. Pat. No. 6,811,308 describes a wireless remote cooking thermometer system that transmits temperature information from a thermometer to a remote unit and provides an audible alarm when a desired temperature is reached.

Traditional food thermometers have been coupling a display form with temperature sensor within the same physical unit. Display of desired parameter(s) such as a current food temperature, distance from desired temperature etc. have been provided by analog meters as well as digital displays. Food temperature indicators such as a temperature sensor have traditionally resided together with the display in traditional food thermometers. With the development of wireless technologies food thermometers were equipped with a transmitter such as a Bluetooth module. Existing food thermometer devices connect a food temperature indicator to a transmitter through an electric cable. Having an electrical wire between the temperature sensor and the transmitter has many disadvantages: It is cumbersome when cooking, it is less safe, it is not machine washable and therefore may be less hygienic, it cannot be used in closed cooking devices such as oven-bags, it lessens the affectivity of cooking adds such as covering aluminum foil and towels and it cannot be used in rotating cooking devices.

Reference is first made to the construction and operation of non-wireless food thermometers and wireless food thermometers having a digital display or a distal transmitter element from the prior art as illustrated in FIGS. 1-4.

Referring to the drawings, FIG. 1 illustrating a prior art food thermometer having a food temperature indicator and a proximal non-digital display. A temperature sensor 1.3 is arranged in a front, first section 1.4 of a housing 1.5. In this front housing section 1.4, there is also located a control and/or analyzing unit 1.6, a voltage source 1.7 in the form of a battery and a temperature indicator 1.8. The sensor, the control and/or analyzing unit and the temperature indicator are preferably formed as electrical/electronic components, which are supplied by the voltage source 1.7. To facilitate the replacement of the battery 1.7 and the maintenance of the electronic components, the housing can be divisible along a parting line 1.9. The housing 1.5 also has a rear, second housing section 10, which during the preparation can remain outside the foodstuff 1.2. At least this rear housing section is made of a material, such as a metal, preferably titanium. Of course, the entire housing can be made uniformly of such a material. At the rear end of the rear housing section, a grip 1.11 is provided, which is to allow insertion of the device into the foodstuff and also its removal. At least one visible status indicator 1.12 is located there, which is optically connected by one or more optical fibers 1.13 arranged within the housing to the temperature indicator 1.8.

Reference is now made to FIG. 2 illustrating a prior art food thermometer 2.30 having a food temperature indicator 2.40 and a proximal digital display 2.130. The food thermometer 2.30 can be controlled by a control element 2.140.

Reference is now made to FIG. 3 illustrating a prior art food thermometer having a food temperature indicator and a distal digital display connected by a long flexible connector. The illustrated food thermometer has a probe having a distal tip 3.152 and temperature sensors 3.154a -3.154h that provide information via leads 3.156 to display unit 3.158 having display 3.160 showing graph 3.162 of temperature versus distance. Graph 3.162 has an exemplary temperature profile 3.164a showing a high ambient temperature (as in defrosting or warming), a relatively Warmer temperature in the exterior object portions 3.164b, a minimal temperature at the approximate center 3.164c and a higher temperature 3.164d at a detector that is located beyond the cool center.

Reference is now made to FIG. 4 illustrating a prior art food thermometer having a food temperature indicator and a distal transmitter unit connected by a long flexible connector. The system 4.10 includes a first unit 4.18 and a second unit or programmable thermometer timer unit 4.12, having display screen 4.14, and data entry keys 4.16. The second unit 4.12 includes one or more microprocessors for operating temperature control programs for cooking meat to preferred temperatures. The data entry keys 4.16 are used by an operator to enter cooking-related information into the timer unit, such as the type of meat being cooked and taste preferences (i.e., Well done). The system 4.10 also includes the first unit 4.18, a remote monitoring and transmitting unit that is capable of monitoring the temperature of the meat being cooked and transmitting the temperature to the second unit 4.12. The first unit 4.18 includes a display screen for showing information related to the cooking operation, such as the temperature of the meat. A temperature probe 4.22 is connected to the remote monitoring first unit. The temperature probe is preferably inserted into the meat being cooked for continuously measuring the internal temperature of the meat. The measured temperature is then carried through communication line 4.24 to the remote monitoring unit. The first unit may include two or more temperature probes for monitoring the temperatures of various pieces of meat.

### SUMMARY OF THE INVENTION

A first aspect of the invention provides a wireless cooking thermometer system comprising:
a food temperature indicator configured to provide a temperature reading,
a wireless transmitter unit operably connected to the food temperature indicator to receive a temperature reading therefrom and to wirelessly transmit an information representing the temperature reading.

In preferred embodiments, the thermometer system comprises a food temperature indicator housing enclosing the food temperature indicator and the transmitter unit.

Some embodiments further comprise a temperature indication receiver unit configured to receive the information representing the temperature reading, the receiver unit being separate from the thermometer housing.

In some embodiments, the receiver unit, if present, or the food temperature indicator housing further comprises a digital processor for providing, based on two or more temperature readings from the food temperature indicator, a prediction of a time at which a temperature reading from the temperature indicator will correspond to a selected or pre-defined target temperature. In some embodiments, the digital processor uses at least three temperature readings to provide the prediction, the providing using an extrapolation-type calculation involving at least the at least three temperature readings and the target temperature.

The receiver unit may be, but is not limited to, a mobile phone, a tablet and a wearable wireless device.

In some embodiments, the transmitter unit uses a Bluetooth standard or an ANT+ protocol.

Some embodiments furthermore comprise an antenna configured to enhance a range of the transmitter unit, the antenna extending from the transmitter unit towards a first end of the housing. In some embodiments the antenna is entirely enclosed in the food temperature indicator housing, or, put in another way, it does not extend out of the housing 5.60.

In some embodiments, the wireless cooking thermometer system comprises exactly two operative temperature indicators.

A specific temperature indicator is “operative” if the thermometer is configured to obtain a temperature reading from it and wirelessly transmit information that depends on that temperature reading.

In some embodiments, the wireless cooking thermometer system comprises exactly one operative temperature indicator.

The thermometer housing may protect the food temperature indicator and the transmitter unit from e.g. water or grease or other substance likely to cause the food temperature indicator, transmitter unit or battery to malfunction. The thermometer housing is in some embodiments sharp or pointy at least in one end, whereby it can more easily be inserted into food items. Also, a rigid thermometer housing, made of a metal or an alloy or plastic material(s) or combination thereof is preferable, since such a housing is more easily inserted into a food item. One section of the thermometer may be made of one type of material while another section is made of a different material.

The nature of a “temperature reading” depends on which type of temperature indicator is used. The information representing the temperature reading might for instance be a value representing an electrical resistance. At a certain temperature, the temperature reading is represented by a first resistance value. At a different temperature, the resistance reading is different. A relationship must be established, preferably pre-established, in order to interpret the temperature reading. This is a matter of design, and the person skilled in the art will readily be able to identify his preferred/required/most suitable implementation in view of the present disclosure.

In some embodiments, a distance between the food temperature indicator and transmitter unit is less than 6 cm, such as less than 4 cm, such as less than 2 cm, such as less than 1 cm. The distance is to be construed as a distance between central parts of the food temperature indicator and the transmitter unit or as a largest distance between a temperature-sensitive part of the food temperature indicator and a temperature-sensitive part of the transmitter unit, or as a largest distance as described in relation to FIG. 6A below. Here, “temperature-sensitive part” refers to a part which will become non-functional if its temperature increases for instance above 90 C. Even if not specified, distances relating to food temperature indicator and transmitter unit and battery and their relative positioning or positioning with respect to other elements, such as the food temperature indicator housing, shall be interpreted as referring to parts of the food temperature indicator, transmitter unit and battery that cannot withstand temperatures above that temperature. One or more of these parts will likely, when subjected to temperatures above for instance 90 C for at least 10 minutes, malfunction, causing the thermometer to malfunction. If a transmitter unit is 5 cm long by virtue for instance of an attached antenna part, such a transmitter unit is not likely to be temperature-sensitive along its entire length. Most likely, the transmitter unit has substantially smaller temperature-sensitive part or parts. With respect to the definition that refers to temperature-sensitive parts, only those parts are to be considered when determining whether an embodiment of a thermometer falls within the scope of the present invention. The antenna is not likely to be significantly damaged by a temperature of for instance 90 C. The temperature-sensitive parts are not relevant if the central parts are considered. Nor are they relevant if the distance described in relation to FIG. 6A is used.

The food temperature indicator and transmitter unit may also be integrated, in which case the dimensions above refer to a distance between central parts of the food temperature indicator part and the transmitter unit part of the integrated device, or to a largest distance between temperature-sensitive parts of the integrated device. The distance condition may also be applied as described in relation to FIG. 6A, which refers to a largest distance.

An advantage of placing the temperature-sensitive elements near each other is that when food temperature indicator housing is inserted in a food, the elements can be covered by smaller items of food. The fact that the elements are inside the food during heating is exactly what protects them from high heat and keeps them in working condition. If the surrounding temperature is lower than around 90 C, the situation is not as critical. However, in an oven operating at, say, 200 C, or over a grill operating at perhaps more than 300 C, it is crucial that the temperature-sensitive parts are covered by the food item. Otherwise, the temperature sensitive elements may be damaged and malfunction. Some embodiments of the thermometer provide a signal indicating that this event is approaching. This may for instance be triggered in a receiver unit by a lack of signal from the transmitter unit, in which case the thermometer may already have been irreparably damaged. Alternatively, as an example, there may be a signaling from the thermometer that the temperature read by the temperature indicator exceeds a threshold, such as for instance 80 C or 90 C; or 100 C or higher, in case the thermometer is able to withstand higher temperatures. Note that the term “temperature-sensitive” is adapted in accordance with the temperature sensitivity of the components. All components are “temperature-sensitive”, since at some temperature they will become non-functional. If the temperature indicator 5.40 or the transmitter unit 5.50 or the battery 5.70 becomes is damaged at a higher temperature, such as at 125 C, then that element is to be construed as temperature-sensitive to that temperature.

In some embodiments, the wireless cooking thermometer system further comprises a temperature indication receiver unit configured to receive the information representing the temperature reading. This allows the temperature readings to be interpreted and communicated to a user. The receiver unit is most likely to be located in an environment which is not subject to high temperatures, such as at temperatures below 60 C. Most likely, it is placed well away from the heat source used for cooking the food item being prepared.

Some embodiments further comprise a digital processor for providing, based on two or more temperature readings from the food temperature indicator, a value representing a first time or a first time interval, the first time or first interval corresponding to a time which is within 10 minutes from a time at which a temperature reading will correspond to a selected or pre-defined target temperature. This allows the receiver unit to provide a signal within 10 minutes from the time at which the food has reached the target temperature. There are numerous ways of implementing the provision of such a first time or first time interval. As an example, the digital processor may use at least two temperature readings to provide said value representing the first time or first time interval, the providing using an extrapolation-like calculation involving at least the at least two temperature readings and the target temperature. Another time period may also be used instead of 10 minutes, for instance 5 minutes.

In some embodiments, the digital processor is located in the food temperature indicator housing, and the digital processor is coupled to the transmitter unit, and the digital processor in configured to control the transmitter unit to transmit a temperature reading when a temperature reading condition is fulfilled. Such a condition might for instance be that the abovementioned first time or first time interval corresponds to a time which is within 10 minutes (or other pre-defined amount of time) from a time at which a temperature reading will correspond to a selected or pre-defined target temperature. This can be based on the extrapolation-like calculation or other suitable method, as will be appreciated by a person skilled in the art in view of the present disclosure.

In some embodiments, the food temperature indicator is located in a substantially central position of the food temperature indicator housing. In some embodiments, an outer surface of the food temperature indicator housing comprises one or more marks, such as line(s) and/or number(s) and/or letter(s), each mark representing a distance from said each mark to the food temperature indicator. In some embodiments of the wireless cooking thermometer system, the transmitter unit uses a Bluetooth standard or an ANT+ protocol.

In some embodiments, an interval between adjacent transmissions by said transmitter unit is responsive to temperature readings by said food temperature indicator.

In some embodiments, the cooking thermometer system comprises an internal power source for powering the transmitter unit and/or the food temperature indicator. In these or other embodiments, power is harvested from a wireless signal surrounding the temperature indicator housing.

In some embodiments of the invention the thermometer housing provides partial isolation against cooking heat between 100 and 250 Celsius degrees.

According to some embodiments of the invention the system the maximal combined length of the food temperature indicator and the transmission enhancer is smaller than 15 centimeters.

In some embodiments of the invention an interval between adjacent transmissions by the transmitter unit is responsive to temperature readings by the food temperature indicator. This allows for instance a battery saving, where a temperature reading is transmitted only when the temperature reading differs from a previous temperature reading by at least a certain amount. There is often no reason to transmit temperature readings that are close to previous temperature readings. In some embodiments, the frequency of transmissions of temperature readings increases in response to an increase in the rate of increase of temperature readings.

Some embodiments of the invention the system further comprise a memory unit storing a plurality of temperature readings from the food temperature indicator.

In some embodiments, the housing provides the transmitter unit partial insulation against conventional cooking heat ranging from up to 350 Celsius degrees or up to 200 Celsius degrees or up to 150 Celsius degrees.

According to some embodiments of the invention an interval between adjacent transmissions by the transmitter unit is responsive to at least one of: a temperature reading by the food temperature indicator, a plurality of temperature readings by the food temperature indicator, a preset desired temperature, a temperature reading by the cooking device temperature indicator and a plurality of temperature readings by the cooking device temperature indicator.

In some embodiments, the food temperature indicator comprises for instance a semiconductor bandgap-based temperature sensor or a temperature-dependent resistor or a thermocouple, or other device or element capable of providing a temperature-dependent indication representing a temperature of a medium to which the device or element is applied or brought into contact with.

According to some embodiments, such as the one shown in FIG. 6C, the food temperature housing may comprise a heat conducting contact element (5.41) located at an external surface of food temperature housing, and optionally, but preferably, the external heat conducting element is connected to the food temperature indicator by a heat transfer element (5,42). Preferably, the heat conducting contact element and/or the heat transfer element are either metal-based or carbon-based. Metallic materials such as steel or copper or copper-based alloys or aluminium or aluminium-based alloys are examples of suitable materials. The metallic material is preferably resistant to corrosion by water and/or urea. The high thermal conductivity ensures fast transfer of heat from the food via the heat conducting contact element and the heat transfer element to the food temperature indicator. This leads to a temperature reading by the food temperature indicator that closely represents the temperature of the food at a point where the heat conducting contact element contacts the food. Using materials with relatively low thermal conductivities will result in temperature readings that less precisely represent the temperature of the food at a given time (depending on the rate of change of the temperature in the food at the heat conducting contact element). Preferably, a thermal conductivity of the heat conducting contact element and a thermal conductivity the heat transfer element is at least 1 W/m/K, such as at least 10 W/m/K, such as at least 100 W/m/K.

In some embodiments the food temperature indicator is located in a lengthwise substantially central position of the thermometer housing.

In some embodiments, an outer surface of the thermometer housing comprises one or more marks, such as line(s) and/or number(s) and/or letter(s), each mark representing a distance from said each mark to the food temperature indicator.

In some embodiments, a smallest external dimension of the food temperature indicator housing is in the interval 1-3 mm and a second external dimension of the food temperature indicator housing is at least twice the size of said smallest dimension. It turns out that such a design, for instance achieved by using a rectangular cross-section, makes it easier to insert the thermometer into a food item. The cross-section needs not be uniform along the length of the food temperature indicator housing.

In some embodiments, the food temperature indicator housing comprises an accelerometer, and the transmitter unit is configured to transmit an information representing an orientation or an acceleration of the food temperature indicator housing.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, prevail. In addition, the materials, methods, and examples are illustrative only and shall not be considered limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage. Optionally, a network connection is provided as well. A display and/or a user input device such as a keyboard or mouse are optionally provided as well.

### BRIEF DESCRIPTION OF THE DRAWINGS

FIG. 1 is a prior art food thermometer having a food temperature indicator and a proximal non-digital display.

FIG. 2 is a prior art food thermometer having a food temperature indicator and a proximal digital display.

FIG. 3 is a prior art food thermometer having a food temperature indicator and a distal digital display connected by a long flexible connector.

FIG. 4 is a prior art food thermometer having a food temperature indicator and a distal transmitter unit connected by a long flexible connector.

FIG. 5 illustrates a pointy wireless cooking thermometer having food a temperature indicator and a proximal transmitter unit, according to some embodiments of the present invention.

FIGS. 6A-6C show schematically various embodiments of the present invention.

FIGS. 7A and 7B illustrate embodiments wherein the food temperature indicator has a central position in the food temperature indicator housing.

FIG. 8A illustrates an embodiment where the food temperature indicator has a central position.

FIG. 8B illustrates an embodiment where the food temperature indicator has a central position and the outer surface of the thermometer housing has markings for aiding in positioning the thermometer in a food item.

FIGS. 9A-9C illustrate embodiments with and without antenna for enhancing the strength of the signal from the transmitter unit.

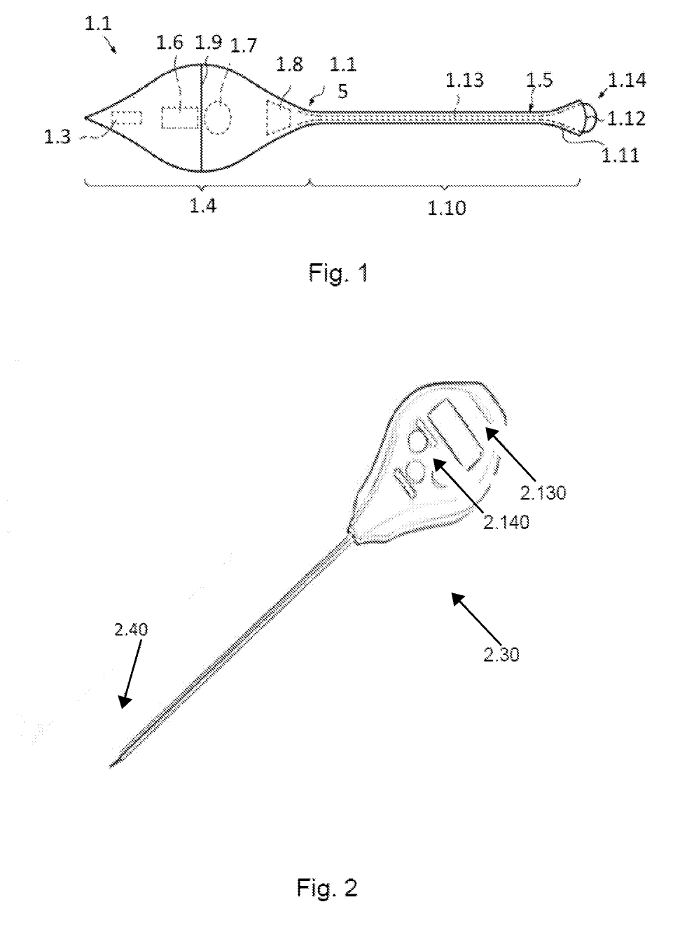

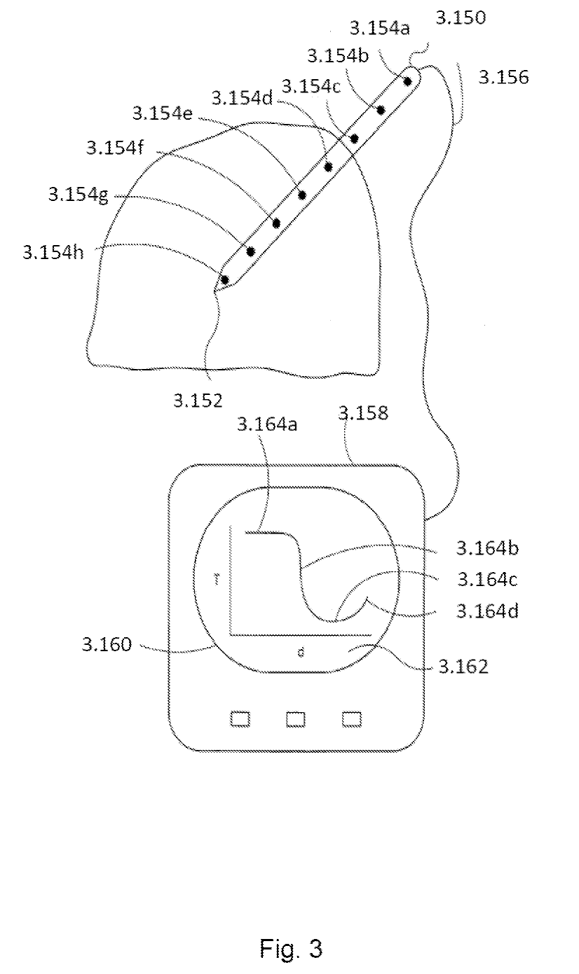

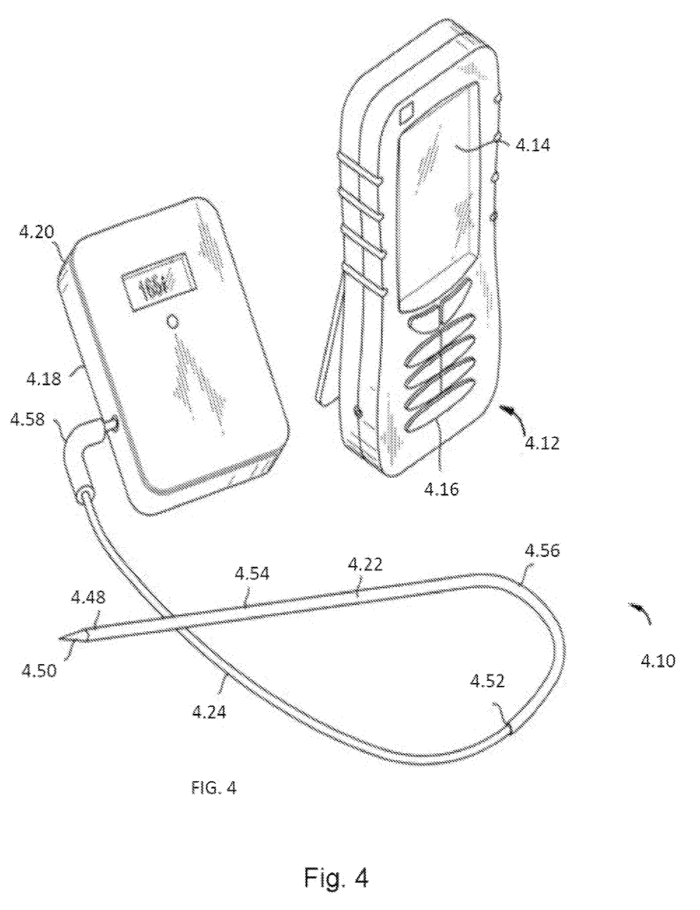

### DESCRIPTION OF SPECIFIC EMBODIMENTS OF THE INVENTION

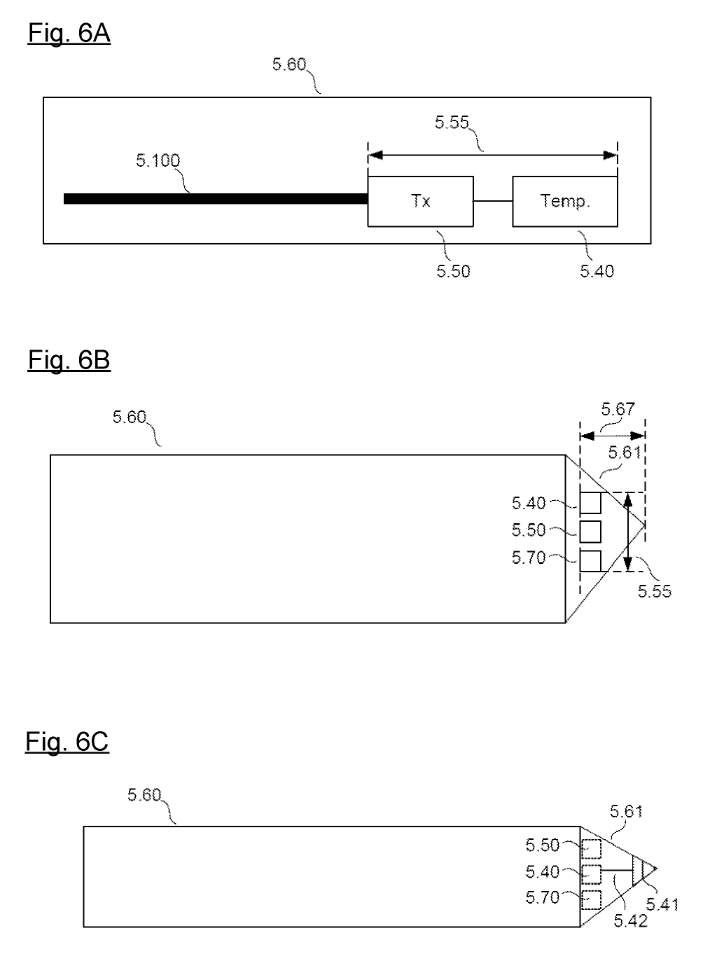

In the following, the invention is illustrated in terms of selected embodiments. Reference is now made to FIG. 6A, which illustrates a wireless cooking thermometer 500 in accordance with an embodiment of the invention. It comprises a housing 5.60, a food temperature indicator 5.40 and a wireless transmitter unit 5.50 operably connected to the food temperature indicator to receive a temperature reading therefrom and to wirelessly transmit an information representing a temperature reading. The embodiment also comprises an antenna 5.100.

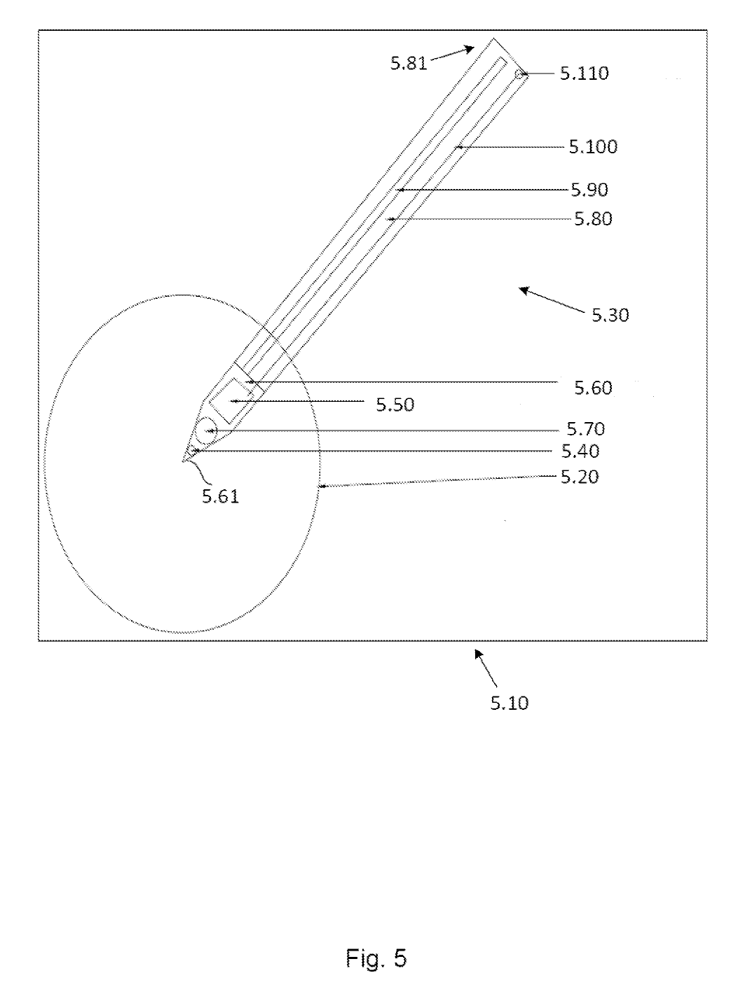

FIG. 5 also illustrates an embodiment of the wireless cooking thermometer 5.30. It comprises a food temperature indicator 5.40 and a wireless transmitter unit 5.50. As used herein, the term food temperature indicator 5.40 means an element capable of taking frequent temperature measurements of a foodstuff. A food 5.20, for instance a meat, a chicken, a fish or a cake, is illustrated in a cooking device 5.10, such as a grill, a rotating barbeque or an oven. The food temperature indicator 5.40 and a transmitter unit 5.50 may be connected to one another by an electrical current carrier. The food temperature indicator 5.40 and a transmitter unit 5.50 are located within a thermometer housing 5.60. The housing 5.60 may also comprise a battery 5.70. The battery 5.70 provides power to the food temperature indicator 5.40 and the transmitter unit 5.50.

The transmission enhancer 5.100 may reside within a transmission enhancer housing 5.80. Typically, however, the food temperature indicator housing houses the food temperature indicator and the transmitter unit A supporting element 5.90 may further reside within the transmission enhancer housing 5.80 thereby protecting its completeness, increasing its endurance, supporting its physical shape, increasing its rigidity and or increasing its ability to penetrate through food. FIG. 5 illustrates an antenna 5.90 that extends from the temperature indicator housing to the enhancer housing. It is therefore most useful to consider the enhancer housing 5.80 as being part of the indicator housing 5.60.

Optionally, the wireless cooking thermometer 5.30 further comprises a cooking device temperature indicator 5.110. The cooking device temperature indicator 5.110 may be mounted on the distal tip 5.81 of the transmission enhancer housing 5.80. As used herein, the term cooking device temperature indicator 5.110 means an element capable of taking frequent temperature measurements of a cooking device such as, but not limited to, a grill, a barbeque and an oven. The transmitter unit 5.50 may transmit the cooking device temperature indicated by the cooking device temperature indicator 5.110 in addition to the food temperature and/or instead of the food temperature measured by the food temperature indicator 5.40.

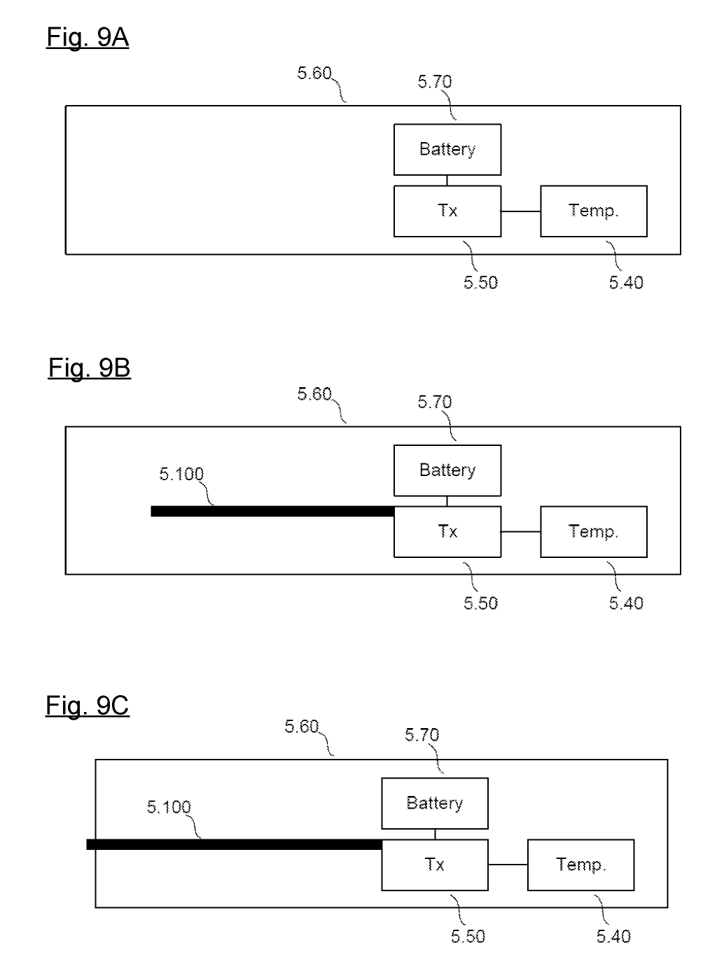

Optionally, the food temperature indicator 5.40 and the cooking device temperature indicator 5.110 are a TI: LM35 component. Optionally, the distal tip 5.81 of the transmission enhancer housing 5.80 is made of stainless steel. Optionally, the supporting element 5.90 is made of Aluminum. Optionally, the transmitter enhancer housing is made of silicon. Optionally, a custom made printed circuit board (PCB) connects the food temperature indicator 5.40, the cooking device temperature indicator 5.110, the power source 5.70, the transmitter unit 5.50 (for example a Bluetooth chip) and the transmission enhancer 5.100 (for example an antenna). Optionally, the PCB further acts as a memory unit, storing temperature reading and other temperature related data. Optionally, the PCB implements an algorithm to determine the transmission interval by the transmitter unit 5.50. FIG. 9A shows schematically a thermometer without an additional antenna. FIG. 9B shows schematically a thermometer with an internal antenna that does not extending out of the housing 5.60, thereby being protected. FIG. 9C shows schematically a thermometer with an internal antenna that extends out of the housing 5.60, thereby providing a slightly stronger signal.

In any case, the invention is at least partly based on the feature that the electronic parts are protected from high heat by locating them within the food being prepared. A distance, D, illustrated with reference number 5.55 in FIG. 6A and 6B, between the transmitter unit 5.50 and the temperature indicator 5.40 can be dependent on the food to be prepared. When preparing a large item of food, the thermometer is advantageously long enough to be inserted into a core of the food where the temperature is lowest. This is one area that is of most interest when preparing food, since a food that has not been sufficiently heated may pose a health risk. Many meats also tend to toughen when reaching higher temperatures, for instance 70 C and above. If preparing for instance a pig or a cow as a spit roast, the distance between the surface of the meat and a core of the meat may be on the order of 50 cm. In that case, the thermometer should be long, such as 50 cm or even more, such as 60 cm, 70 cm, or 80 cm, or even more.

On the other hand, it allows the transmitter unit, temperature indicator and power source to be located with larger mutual distances, since the meat protects them from the temperatures of meat located closer to the surface of the food, where the temperature is higher. Typically, roasts and other foods being prepared in ovens or on spits or other heat sources have a distance from their surface to their core of less than about 20 cm, such as less than 15 cm, such as less than 10 cm, such as less than 5 cm. In order for the thermometer to function well also for smaller items of food, the temperature-sensitive elements—i.e. the food temperature indicator, the transmitter unit and, when included, a battery power source—are preferably placed within a region that is surrounded by food even for small items of food. This includes items of food dimensioned as mentioned above. Some embodiments are configured to operate also in smaller items of food, for instance in items wherein the distance from the surface of the food to a core of the food is not just less than the abovementioned distances, but even less than 3 cm or 2 cm or 1 cm. Accordingly, at least two of the temperature-sensitive elements are preferably located within a region of a corresponding or smaller size. FIG. 6A and 6B illustrate a largest distance 5.55 between the transmitter unit and the temperature indicator. No absolute size is implied in the figure. Also, FIGS. 6A and 6B refer to the entire elements, not only to temperature-sensitive parts.

FIG. 6C illustrates a thermometer having a dedicated external heat conducting element 5.41 for allowing heat to quickly be transferred to the temperature indicator 5.40 via heat transfer element 5.42. In some embodiments, the housing 5.60 is made of or (at least partly) covered by a material with a relatively low thermal conductivity. In that case, an external heat conducting element 5.41 can provide more effective transfer of heat from the food to the temperature indicator.

The position of the temperature-sensitive elements relative to the housing 5.60 may also be varied between embodiments. For instance, at least two of them (such as the temperature indicator and the transmitter unit) or all three may be placed within a distance (illustrated with reference 5.67 in FIG. 6B) from the (pointy) tip 5.61 of for instance 5 cm or 4 cm or 3 cm or 2 cm or 1 cm, or as close as their sizes allow.

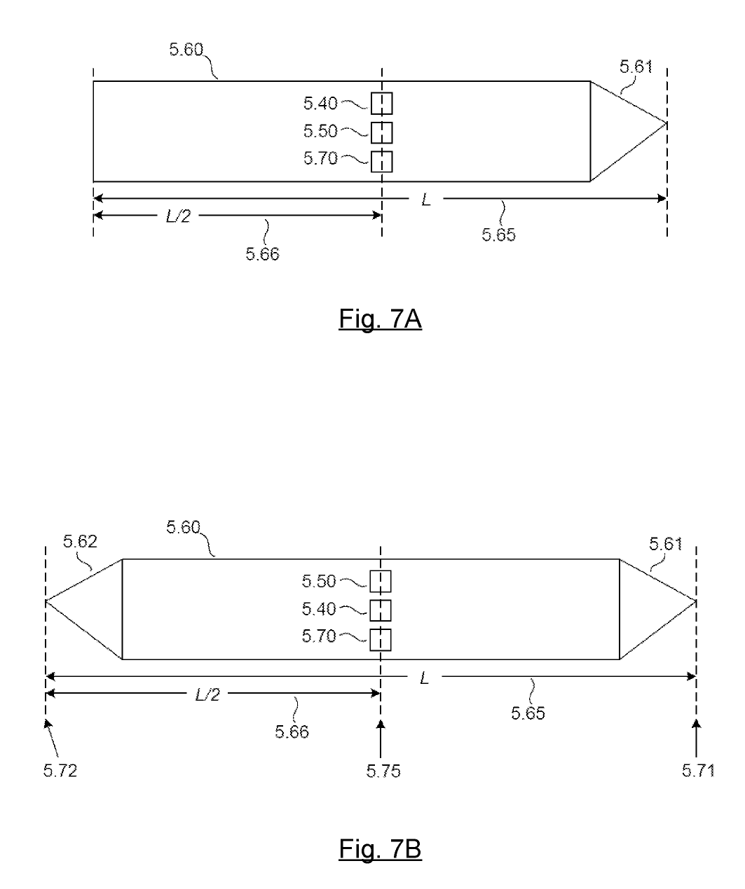

In the embodiments illustrated in FIGS. 7A and 7B, the temperature-sensitive elements are located substantially in the middle of the thermometer in a lengthwise direction, i.e. considered along a longest dimension of the thermometer. In FIGS. 7A and 7B, the length 5.65 of the thermometer is L, and the transmitter unit 5.50, temperature indicator 5.40 and battery 5.70 are located a distance 5.66 substantially halfway, L/2, from either end of the thermometer. In these embodiments, it may be easier to ensure that a temperature reading is taken as close as possible to the core of the food. By visually determining that the thermometer extends by substantially the same length outside both sides of the food, this is ensured.

FIG. 7B shows a substantially symmetric thermometer having the temperature-sensitive elements near halfway in a lengthwise direction. An advantage of this embodiment is that it is easier to judge that the thermometer has been inserted in such a way that the temperature indicator, which reads the temperature, is placed as close as possible to the core of the food, as also described above. In FIG. 7A and 7B, the second end 5.61 is illustrated as pointy and/or sharp, allowing more easy insertion of the thermometer into the food. In FIG. 7B, the first end 5.62 has substantially the same shape as the second end 5.61. This allows for easy insertion of the thermometer into the food from either end of the thermometer.

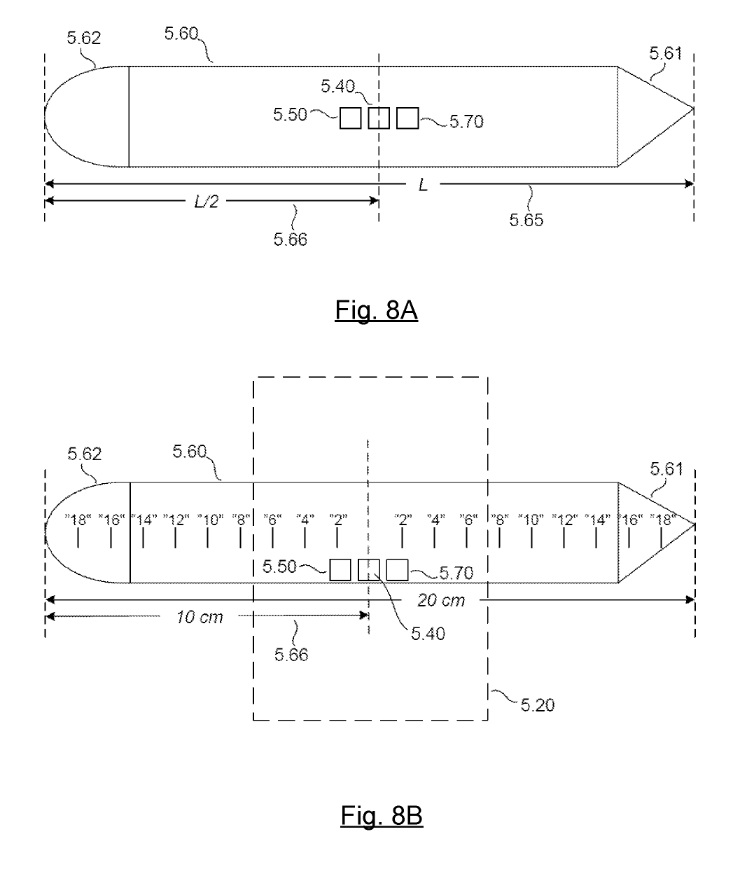

Alternatively, as shown in FIGS. 8A and 8B, the other end 5.62 can be dull to allow it to be used for leverage in pushing the pointy or sharp end 5.61 into the food. Other shapes are of course also available. Factors such as handling and aesthetics might influence the choice of shape. If the dimensions resemble those of the second end 5.61, it is easier to allow easy judgment of whether the thermometer is inserted half way.

In some embodiments, such as that shown in FIG. 8B, markings starting from the middle of the thermometer can allow even more precise insertion or measurement of the thickness of the meat. For illustrative purposes only, not as a limitation of the scope of the invention as defined by the claims, the thermometer is shown as being 20 cm long. The temperature-sensitive parts are located in a substantially central position of the food temperature indicator housing near the center of the thermometer in a lengthwise direction, i.e. around 10 cm from either end 5.61 and 5.62. It may or may not also be a central position in another direction. Although a central position in more than one direction is often desirable, a more peripheral position in a perpendicular direction, may be desirable. This is illustrated in FIG. 8B. For illustrative purposes, the markings in FIG. 8B are illustrated as being separated by 1 cm (optionally with a marking in the middle of the thermometer along the long axis). The markings can be spaced further or closer to one another. In FIG. 8B, the printed numbers are cm-indications. The dashed box 5.20 illustrates a item of food, such as a piece of meat, into which the thermometer might be inserted. The thermometer has been inserted into the meat in such a way that the distance from both sides of the piece of meat has about the same distance from both “8”-markings. The markings that fall inside the meat 5.20 will not be visible since they are covered by the meat. The numbers change by 2 from marking to marking because when the thermometer is inserted into the meat in a symmetric fashion, the marking will show the thickness of the meat along the direction of insertion. In the example, this thickness is just below 8 cm. Further markings will allow a more precise determination of thickness, if desired. For the purpose of inserting the thermometer so that the temperature indicator 5.40 is as close to the center of the piece of meat as possible, the illustrated markings provide a good aid. This thermometer will be useful for foods with a thickness up to about 20 cm. The thermometer can be shorter or longer, depending on the thickness of the food into which it is expected to be inserted. Even though the thermometer is twice as long compared to what is necessary if the temperature indicator is located at an end of the thermometer, as in FIGS. 6B and 6C, the cost needs only be slightly higher. The electronics is the same, so it is mostly the cost of the extra housing material that determines the extra cost.

FIG. 9A shows schematically a thermometer without an additional antenna. (Only one end of the housing 5.60 is shown in this and in FIGS. 9A-9C.) FIG. 9B shows schematically a thermometer with an internal antenna that does not extend outside of the housing 5.60, thereby not receiving direct heat from outside the housing. FIG. 9C shows schematically a thermometer with an internal antenna that extends out of the housing 5.60, thereby providing a slightly stronger signal, but also working as a heat conductor that will transfer heat from outside the housing to the inside of the housing where the temperature-sensitive parts are located.

Optionally, the food temperature indicator 5.40 is a TI: LM35 component. Optionally, the transmitter unit is a Bluetooth module, such as a TDK: SESUB-PAN-T2541. Alternatively, the transmitter unit uses an ANT+ protocol. Although Bluetooth and ANT+are currently prevailing technologies, other options exist that may be used instead. Optionally, the power source 5.70 is a Panasonic BR125A battery or other battery providing appropriate power to enable the reading of temperature and/or transmitting the information representing the temperature reading.

It is expected that during the life of a patent maturing from this application many relevant temperature indicators, transmitter units, receiver units, power sources, housing materials and memory units will be developed and the scope of the terms temperature indicators, transmitter units, receiver units, power sources, housing materials and memory units are intended to include all such new technologies a priori.

As used herein the term “about” and “substantially” refers to a deviation of at most ±20%. For instance, in a thermometer having a total length of 10 cm, a central position is 5 cm from each end of the thermometer housing. A distance of 4 cm from a first end of the thermometer housing is “substantially central”, being 20% less than 5 cm. (The distance from the other end will be 6 cm, 20% more than 5 cm).

The terms “comprises”, “comprising”, “includes”, “including”, “having” and their conjugates mean “including but not limited to”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the wording of the appended claims.

1. A wireless cooking thermometer system, comprising:
a food temperature indicator configured to provide a temperature reading,
a wireless transmitter unit operably connected to the food temperature indicator to receive a temperature reading therefrom and to wirelessly transmit an information representing the temperature reading.

2. A wireless cooking thermometer system in accordance with claim 1, further comprising a food temperature indicator housing, the temperature indicator housing comprising the food temperature indicator and the transmitter unit.

3. A wireless cooking thermometer system in accordance with claim 1, wherein a largest distance between a temperature-sensitive part of the food temperature indicator and a temperature-sensitive part of the transmitter unit is less than 6 cm, such as less than 4 cm, such as less than 2 cm, such as less than 1 cm.

4. A wireless cooking thermometer system in accordance with claim 1, wherein a distance between central parts of the food temperature indicator and the transmitter unit is less than 6 cm, such as less than 4 cm, such as less than 2 cm, such as less than 1 cm.

5. A wireless cooking thermometer system in accordance with claim 2, wherein the food temperature indicator is located within 6 cm, such as within 3 cm, from an end of the food temperature indicator housing.

6. A wireless cooking thermometer system in accordance with claim 2, wherein the food temperature indicator is located within 6 cm, such as within 3 cm, from a pointy or sharp end of the food temperature indicator housing.

7. A wireless cooking thermometer system in accordance with claim 1, further comprising a temperature indication receiver unit configured to receive the information representing the temperature reading.

8. A wireless cooking thermometer system in accordance with claim 1, further comprising a food temperature indicator housing, the temperature indicator housing comprising the food temperature indicator and the transmitter unit, and the receiver unit or food temperature indicator housing further comprises a digital processor for providing, based on one or more temperature readings from the food temperature indicator, a value representing a first time or a first time interval, the first time or first interval corresponding to a time which is within 10 minutes from a time at which a temperature reading will correspond to a selected or pre-defined target temperature.

9. A wireless cooking themiometer system in accordance with claim 8, wherein the digital processor uses at least two temperature readings to provide said value representing the first time or first time interval, the providing using an extrapolation-like calculation involving at least the at least two temperature readings and the target temperature.

10. A wireless cooking thermometer system in accordance with claim 1, comprising a transmission enhancer housing, and a tip of the transmission enhancer housing is made of stainless steel, and the tip is distal from the transmitter unit.

11. A wireless cooking thermometer system in accordance with claim 1, wherein the transmitter unit uses a Bluetooth standard or an ANT+ protocol.

12. A wireless cooking thermometer system in accordance with claim 2, wherein the food temperature indicator is located in a substantially central position of the food temperature indicator housing.

13. A wireless cooking thermometer system in accordance with claim 12, wherein an outer surface of the food temperature indicator housing comprises one or more marks, such as line(s) and/or number(s) and/or letter(s), each mark representing a distance from said each mark to the food temperature indicator.

14. A wireless cooking thermometer system in accordance with claim 2, further comprising a cooking device temperature indicator configured to take frequent temperature measurements of an ambient temperature.

15. A wireless cooking thermometer system in accordance with claim 14, wherein a printed circuit board connects the food temperature indicator, a cooking device temperature indicator, a power source, the transmitter unit and a transmission enhancer.

16. A wireless cooking thermometer system in accordance with claim 14, wherein the transmitter unit is configured to transmit said frequent temperature measurements.

17. A wireless cooking thermometer system in accordance with claim 2, wherein at least two elements from the set consisting of {the food temperature indicator, the transmitter unit, a battery for powering the food temperature indicator and the transmitter unit} are placed within a distance of 5 cm from a pointy tip of the indicator housing.

18. A wireless cooking thermometer system in accordance with claim 1, comprising exactly one operative temperature indicator.

19. A wireless cooking thermometer system in accordance with claim 1, comprising exactly two operative temperature indicators.

20. A wireless cooking thermometer system in accordance with claim 2, wherein the food temperature indicator housing comprises a heat conducting contact element located at an external surface of the food temperature indicator housing.

21. A wireless cooking thermometer system in accordance with claim 20, wherein heat conducting contact element is connected to the food temperature indicator by a heat transfer element.

22. A wireless cooking thermometer system in accordance with claim 20, wherein heat conducting contact element and/or the heat transfer element is metal-based, such as made from steel or copper or copper-based alloys or from aluminium or aluminium-based alloys.

23. A wireless cooking thermometer system in accordance with claim 2, wherein a smallest external dimension of the food temperature indicator housing is in the interval 1-3 mm and a second external dimension of the food temperature indicator housing is at least twice the size of said smallest dimension.

24. A wireless cooking thermometer system in accordance with claim 2, wherein the food temperature indicator housing comprises an accelerometer, and the transmitter unit is configured to wirelessly transmit an information representing an orientation or an acceleration of the food temperature indicator housing.
